(19) United States
(12) Patent Application Publication
(10) Pub. No.: US 2016/0309736 A1
(43) Pub. Date: Oct. 27, 2016

(54) CANDY AND CANDLE COMBINATION ASSEMBLY

(71) Applicant: Roger Williams, Clarksville, TN (US)

(72) Inventor: Roger Williams, Clarksville, TN (US)

(21) Appl. No.: 14/692,890

(22) Filed: Apr. 22, 2015

(51) Int. Cl. A23G 3/50; F23D 3/16

(52) U.S. Cl. CPC A23G 3/50; F23D 3/16; A23V 2002/00

(57) ABSTRACT

A candy and candle combination assembly includes an embodiment of the disclosure meets the needs presented above by generally comprising a base that has a bottom end, a top end and a perimeter wall attached to and extending between the top and bottom ends. The base is comprised of an edible material. A wax stick has a lower end and an upper end. A wick is positioned in the wax stick and extends upwardly from the upper end. The lower end extends into the top end of the base. The base is extendable into a cake and the wick ignited.

### BACKGROUND OF THE DISCLOSURE

### Field of the Disclosure

The disclosure relates to celebratory candle devices and more particularly pertains to a new celebratory candle device for using with birthday cakes and other types of celebrations where candles are utilized.

### SUMMARY OF THE DISCLOSURE

An embodiment of the disclosure meets the needs presented above by generally comprising a base that has a bottom end, a top end and a perimeter wall attached to and extending between the top and bottom ends. The base is comprised of an edible material. A wax stick has a lower end and an upper end. A wick is positioned in the wax stick and extends upwardly from the upper end. The lower end extends into the top end of the base. The base is extendable into a cake and the wick ignited.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a candy and candle combination assembly according to an embodiment of the disclosure.

FIG. 2 is a front perspective view of an embodiment of the disclosure.

FIG. 3 is a side view of an embodiment of the disclosure.

FIG. 4 is a cross-sectional view of an embodiment of the disclosure taken along line 4-4 of FIG. 3.

FIG. 5 is a front view of an embodiment of the disclosure.

FIG. 6 is a front perspective view of an embodiment of the disclosure.

FIG. 7 is a cross-sectional view of an embodiment of the disclosure taken along line 7-7 of FIG. 6.

FIG. 8 is a cross-sectional view of an embodiment of the disclosure.

### DESCRIPTION OF THE PREFERRED EMBODIMENT

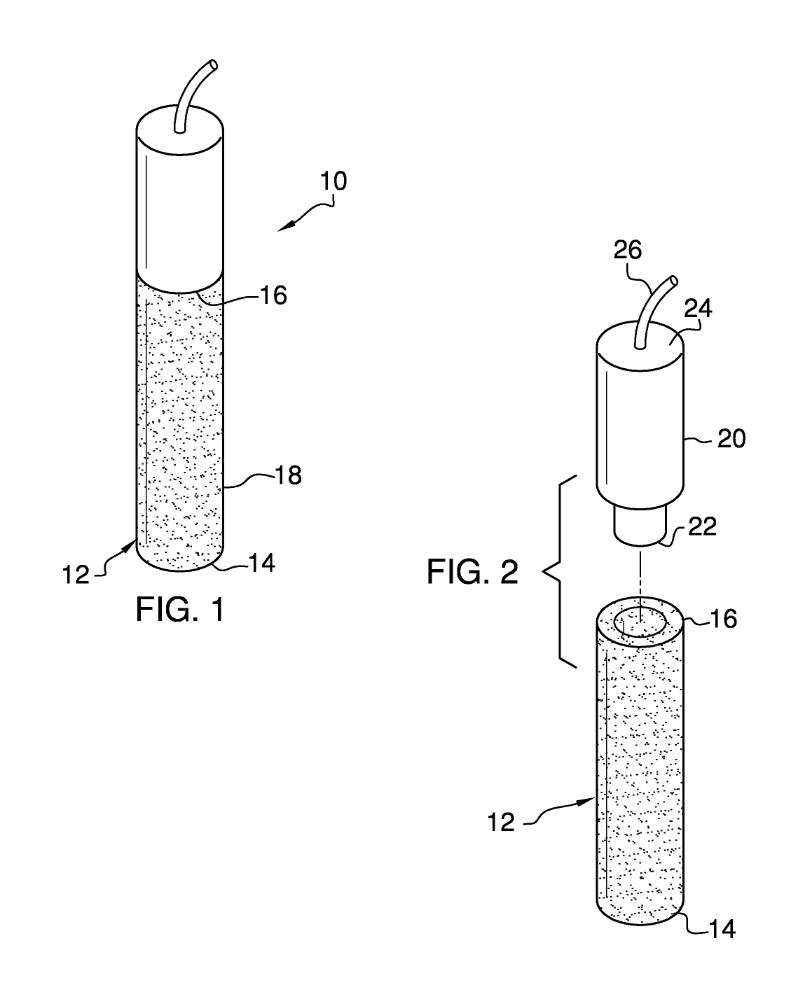

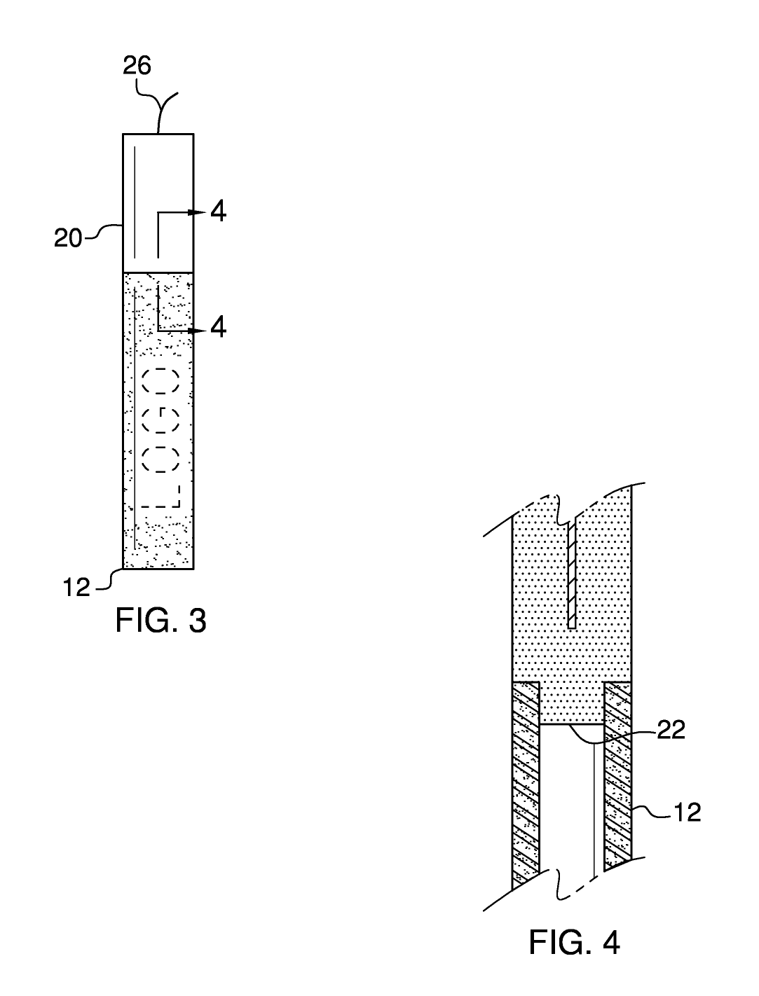

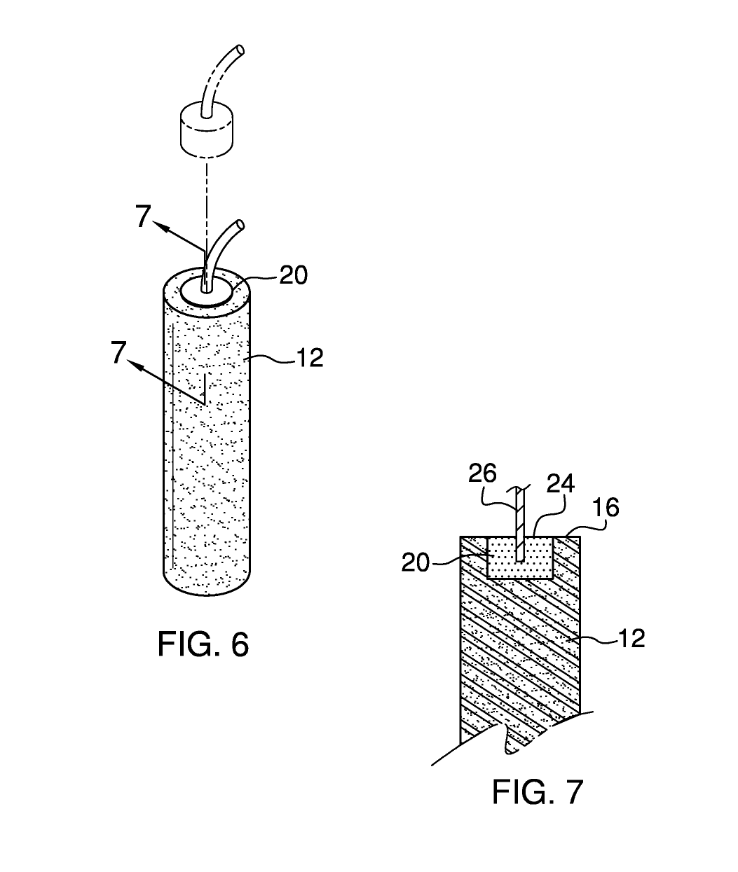

With reference now to the drawings, and in particular to FIGS. 1 through 8 thereof, a new celebratory candle device embodying the principles and concepts of an embodiment of the disclosure and generally designated by the reference numeral 10 will be described.

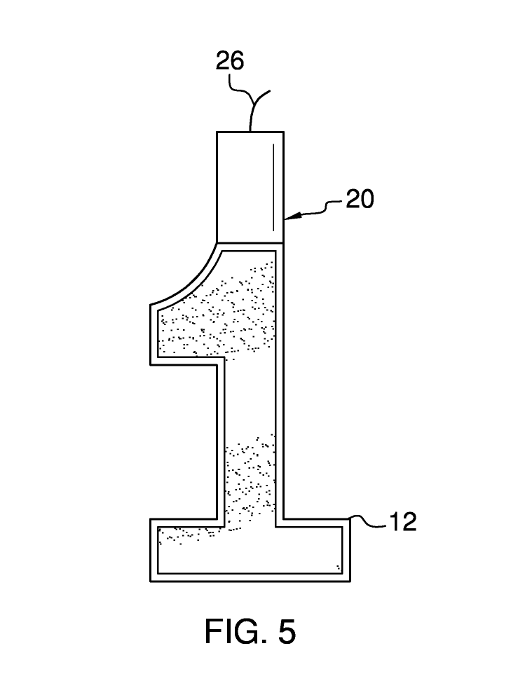

As best illustrated in FIGS. 1 through 8, the candy and candle combination assembly 10 generally comprises a base 12 that has a bottom end 14, a top end 16 and a perimeter wall 18 that is attached to and extends between the top 16 and bottom 14 ends. The base 12 is comprised of an edible material and more particularly the edible material may comprise a confection. While the exact composition of the confection may vary, typically the confection would comprise a hard sugared candy which is rigid and resists easy breakage such that it may be easily inserted into a cake or other baked food with which conventional candles are typically used. The base 12 may have any number of shapes though cylindrical shapes and those shapes which resemble alpha-numeric symbols, such as shown in FIG. 5, may be most preferred such as for usage with birthday cakes. Alternate shapes, however, may be provided as needed.

A wax stick 20 has a lower end 22 and an upper end 24. A wick 26 is positioned in the wax stick 20 and extends upwardly from the upper end 24. The lower end 22 extends into the top end 16 of the base 12. The wax stick 20 and wick 26 comprise a generally conventional candle and the wax stick 20 may be removable from the base 12. As can be seen in the Figures, the wax stick 20 may be positioned such that it extends only partially into the base 12, however, as can be seen in FIG. 7, the wax stick 20 may also have its upper end 24 being flush with the top end 16 and thus may not be easily removable from the base 12.

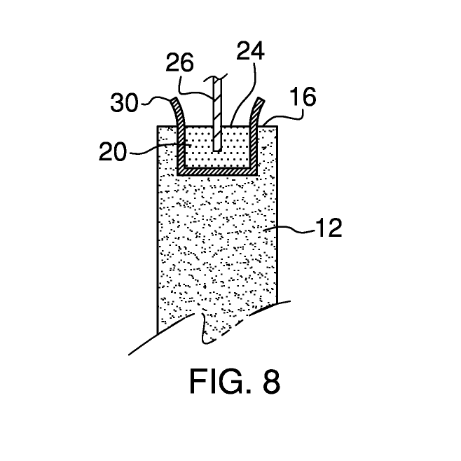

FIG. 8 shows an embodiment of the invention wherein foil 30 is positioned around the wax stick 20 may extend upwardly from the wax stick 20. The foil 30 may be comprised of a metallic material such as aluminum or metals conventional to heat resistant foils. The foil 30 restricts heat transfer between the wax stick 20 and the base 12 and more particularly may prevent the candy from being ignited from fire when the wick 26 is ignited. Additionally, the foil 30 may be used as needed to assist a person in removing the wax stick 20 for the base 12. In this manner, the foil 30 is wrapped around a base of the wick 26 and gripped to pull the wax stick 20 and foil 30 out of or off of the base 12. It should be understood that the foil 30 may be used with all variants of wax sticks 20 and bases discussed herein and shown in the Figures.

In use, the assembly 10 is used in a conventional manner with respect to candles used for birthdays and other celebrations wherein the base 1 is extended into a cake and the wick 26 is lit on fire. After the fire has been blown out, the base 12 may be removed from the cake and eaten.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A candle and candy combination assembly comprising:
a base having a bottom end, a top end and a perimeter wall being attached to and extending between said top and bottom ends, said base being comprised of an edible material, said base being configured to be extended into a cake;
a wax stick having a lower end and an upper end, a wick being positioned in said wax stick and extending upwardly from said upper end, said lower end extending into said top end of said base.

2. The candle and candy combination assembly according to claim 1, wherein said edible material comprising a confection.

3. The candle and candy combination assembly according to claim 1, wherein said wax stick is removable from said base.

4. The candle and candy combination assembly according to claim 1, wherein said base has a shape resembling a number.

5. A candle and candy combination assembly comprising:
a base having a bottom end, a top end and a perimeter wall being attached to and extending between said top and bottom ends, said base being comprised of an edible material, said edible material comprising a confection, said base being configured to be extended into a cake;
a wax stick having a lower end and an upper end, a wick being positioned in said wax stick and extending upwardly from said upper end, said lower end extending into said top end of said base, said wax stick being removable from said base; and
said base having a shape resembling a number.
